(19) United States
(12) Patent Application Publication
(10) Pub. No.: US 2018/0260105 A1
(43) Pub. Date: Sep. 13, 2018

(54) METHOD FOR DISPLAYING SUB-SCREEN AND DEVICE USING THE SAME

(71) Applicants: NANNING FUGUI PRECISION INDUSTRIAL CO., LTD., Nanning (CN); HON HAI PRECISION INDUSTRY CO., LTD., New Taipei (TW)

(72) Inventor: PO-YU LIN, New Taipei (TW)

(73) Assignees: NANNING FUGUI PRECISION INDUSTRIAL CO., LTD., Nanning (CN); HON HAI PRECISION INDUSTRY CO., LTD., New Taipei (TW)

(21) Appl. No.: 15/461,996

(22) Filed: Mar. 17, 2017

Related U.S. Application Data
(63) Continuation-in-part of application No. 15/452,867, filed on Mar. 8, 2017.

(51) Int. Cl. G06F 3/0484; G06F 3/0488; G06K 9/00

(52) U.S. Cl. CPC G06F 3/04847; G06F 2203/04803; G06K 9/00228; G06F 3/0488

(57) ABSTRACT

A method for displaying multiple independent sub-screens on a single display of an electronic device comprises step of capturing at least one facial feature of at least one operator and at least one sub-screen controlling gesture posed by the at least one operator within a predefine area of an electronic device. The electronic device is controlled to establish, merge, or delete at least one sub-screen according to the captured at least one sub-screen controlling gesture. The electronic device is controlled to store a relationship between the at least one facial feature of the operator and the sub-screen. A device of displaying sub-screen is also provided.

### CROSS-REFERENCE TO RELATED APPLICATIONS

The present application is a continuation-in-part application of U.S. Ser. No. 15/452,867, filed on Mar. 8, 2017, the contents of which are hereby incorporated by reference.

### FIELD

The subject matter herein generally relates to electronic displays.

### BACKGROUND

Different users may wish to use his own sub-screen of a display screen of a television. In the prior art, a sub-screen mode is switched into by using special keys of a remote controller, and then operations such as establishing, adding or deleting sub-screens can be manually executed by the remote controller.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a flowchart of an exemplary embodiment of a method for providing a sub-screen display.

FIG. 2 is a schematic diagram of an exemplary embodiment of a controlling gesture in the method of FIG. 1.

FIGS. 3-1-3-3 show exemplary embodiments for establishing a sub-screen in the method of FIG. 1.

FIG. 3-4 is a schematic diagram of an exemplary embodiment for merging sub-screens in the method of FIG. 1.

FIGS. 3-5-3-6 show exemplary embodiments for deleting a sub-screen in the method of FIG. 1.

FIG. 3-7 is a schematic diagram of an exemplary embodiment for suspending or hiding a sub-screen in the method of FIG. 1.

FIG. 3-8 is a schematic diagram of an exemplary embodiment for displaying or playing a sub-screen in the method of FIG. 1.

FIG. 4 is a block diagram of an exemplary embodiment of an electronic device for executing the method of displaying sub-screen of FIG. 1.

FIG. 5 is a block diagram of an exemplary embodiment of a device of displaying sub-screen for the method of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts have been exaggerated to better illustrate details and features of the present disclosure.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to a method of displaying sub-screens. The method comprises steps as follows. Facial features of at least one operator are captured together with at least one sub-screen controlling gesture posed within a predefined area of an electronic device by the at least one operator. The electronic device is controlled to establish, merge, or delete at least one sub-screen according to the at least one captured sub-screen controlling gesture. The electronic device is controlled to store a relationship between the captured facial features of the at least one operator and the sub-screen. A device of displaying sub-screen is also provided.

The present disclosure is described in relation to a device of displaying sub-screens. The device of displaying sub-screen comprises a plurality of processors and a plurality of non-transitory computer storage mediums, coupled to the plurality of processors and configured to store instructions for execution by the plurality of processors. The instructions cause the plurality of processors to capture facial features of at least one operator and at least one sub-screen controlling gesture posed within a predefined area of an electronic device by the operator. The electronic device is controlled to establish, merge, or delete at least one sub-screen according to the at least one captured sub-screen controlling gesture, and further to store a relationship between the captured facial features of the at least one operator and the sub-screen.

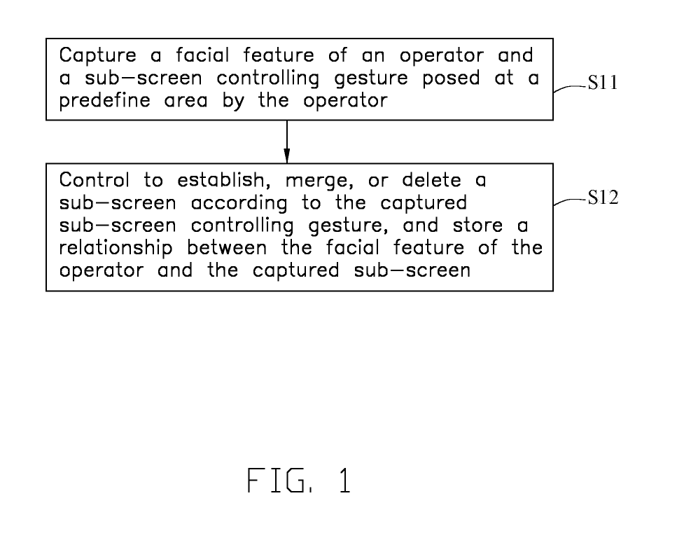

FIG. 1 shows a flowchart of an exemplary embodiment of a method of displaying sub-screen. The method is applied on an electronic device. The electronic device can be, but is not limited to, a smart television, a telephone, a tablet computer, or other suitable electronic device both having displaying and human-computer interaction function. As shown in FIG. 1, the method can include steps S11 and S12.

At step S11, a capturing unit captures at least one facial feature of at least one operator and a sub-screen controlling gesture posed by the at least one operator within a predefined area of the electronic device.

In detail, the capturing unit is mounted on the electronic device or located adjacent to the electronic device. The capturing unit can be, but is not limited to, a camera, a three-dimensional depth motion sensor, or the like. When the operator is located in front of the electronic device and watching the electronic device, the capturing unit can capture the facial features of the operator and gestures posed by the operator.

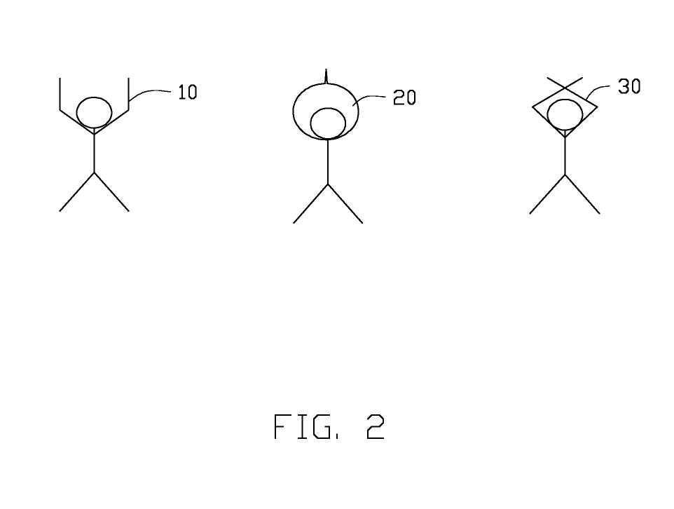

As shown in FIG. 2, the sub-screen controlling gestures can include a sub-screen establishing gesture 10, a sub-screen merging gesture 20, and a sub-screen deleting gesture 30. Therein, the sub-screen establishing gesture 10 is two hands held over the head of the operator without touching one another. The sub-screen merging gesture 20 is the two hands clasping over the head of the operator. The sub-screen deleting gesture 30 is the two hands crossing over the head of the operator.

At step S12: the electronic device is controlled to establish, merge, or delete a sub-screen according to the captured sub-screen controlling gesture, and store a relationship between the captured facial feature of the operator and the sub-screen.

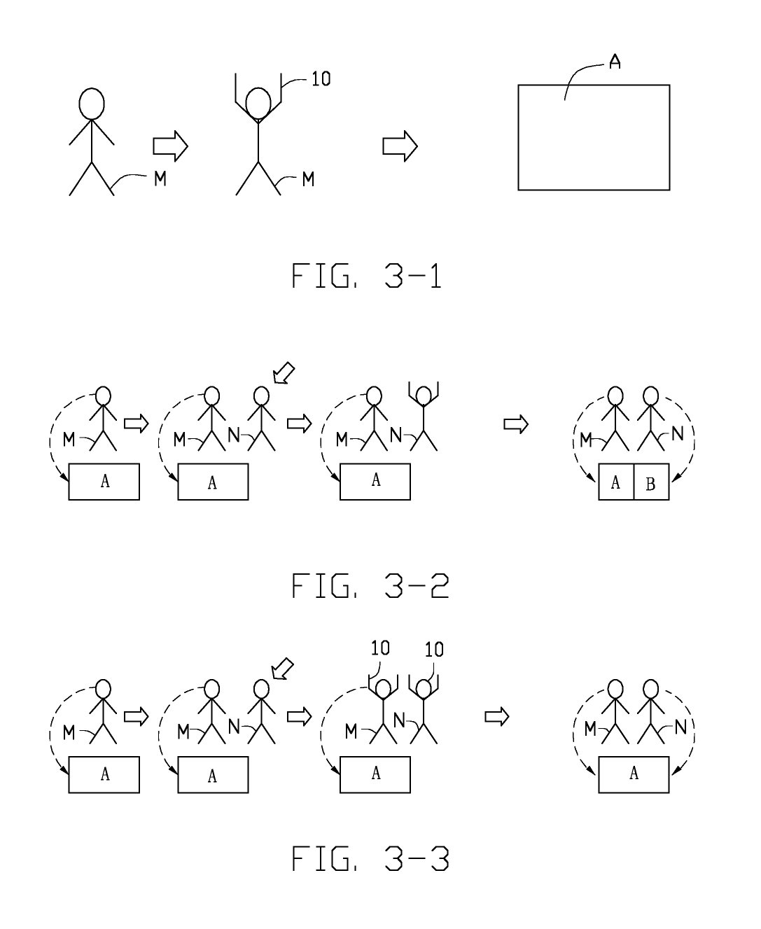

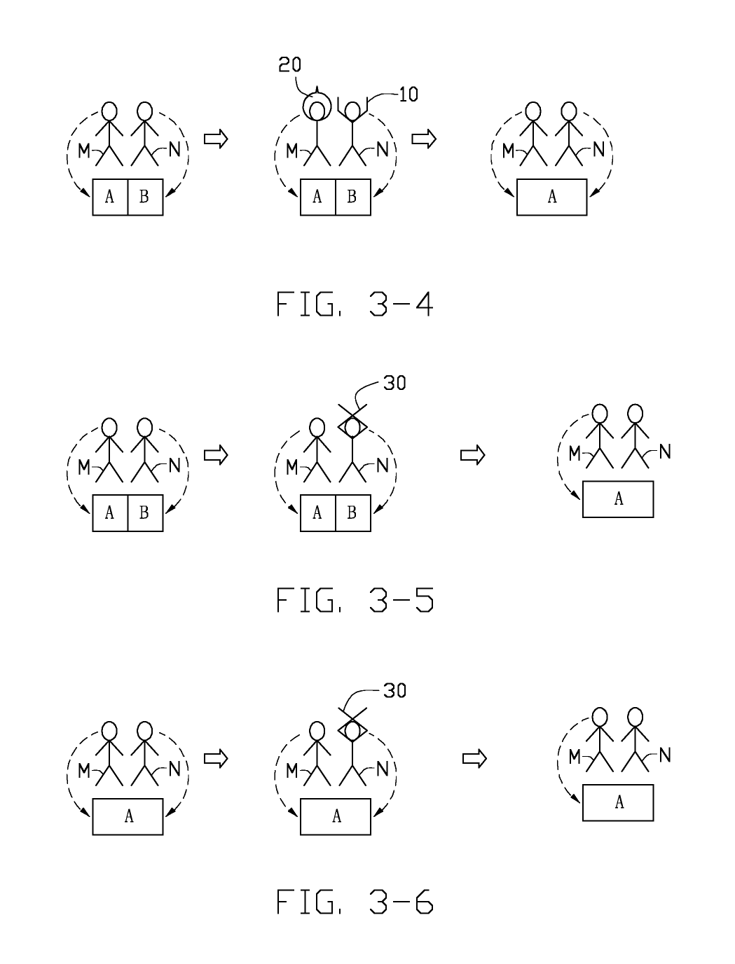

As shown in FIG. 3-1, when only an operator M enters the predefined area of the electronic device and poses the sub-screen establishing gesture 10. The capturing unit captures the sub-screen establishing gesture 10 posed by the operator M and the facial feature of the operator M. The electronic device is controlled to establish a sub-screen A corresponding to the operator M according to the sub-screen establishing gesture 10 posed by the operator M. The electronic device is further controlled to store a relationship between the facial feature of the operator M and the sub-screen A. Therein, the sub-screen A can expand to cover the screen of the electronic device fully. For example, the sub-screen A can display a basketball game.

As shown in FIG. 3-2, when the operator M is within the predefined area of the electronic device and watching the sub-screen A, another operator N may enter the predefined area of the electronic device and pose the sub-screen establishing gesture 10. The capturing unit captures the sub-screen establishing gesture 10 posed by the operator N and the facial feature of the operator N. The electronic device is controlled to establish a sub-screen B corresponding to the operator N according to the sub-screen establishing gesture 10 posed by the operator N. The electronic device is controlled to store a relationship between the facial feature of the operator N and the sub-screen B. Therein, the sub-screen A and the sub-screen B cooperatively cover the screen of the electronic device. For example, the sub-screen A displays the basketball game, the sub-screen B displays a cartoon show.

As shown in FIG. 3-3, the operator M is in the predefined area of the electronic device and watching the sub-screen A. Another operator N enters the predefined area of the electronic device and poses the sub-screen establishing gesture 10 at the same time as the operator M, who is also posing the sub-screen establishing gesture 10. The capturing unit captures the sub-screen establishing gesture 10 posed by the operator M and the facial feature of the operator M. The capturing unit captures the sub-screen establishing gesture 10 posed by the operator N and the facial feature of the operator N. The electronic device is controlled to add the operator N as an co-operator of the sub-screen A according to the sub-screen establishing gesture 10 posed by the operator M and the sub-screen establishing gesture 10 posed by the operator N. The electronic device is further controlled to store a relationship between the facial feature of the operator N and the sub-screen A in addition to the relationship between operator M and sub-screen A.

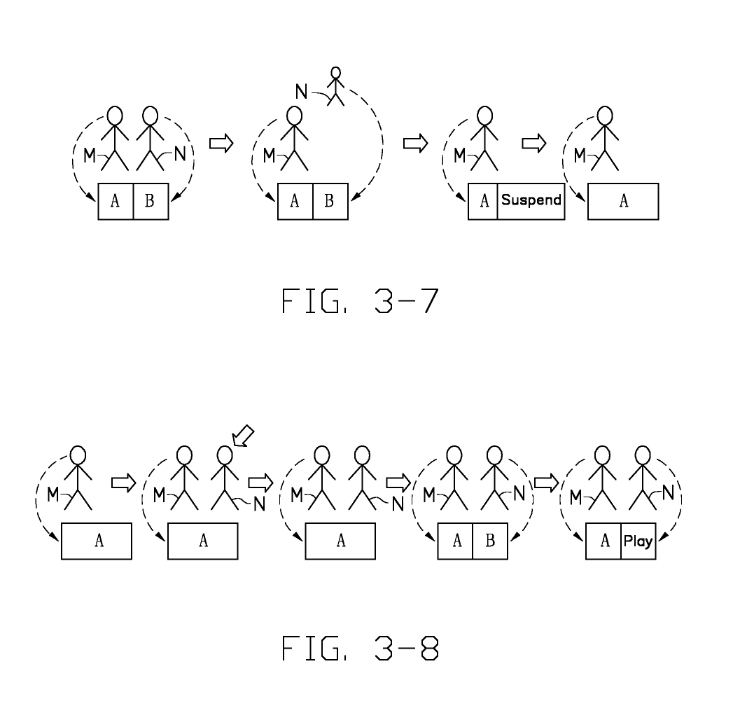

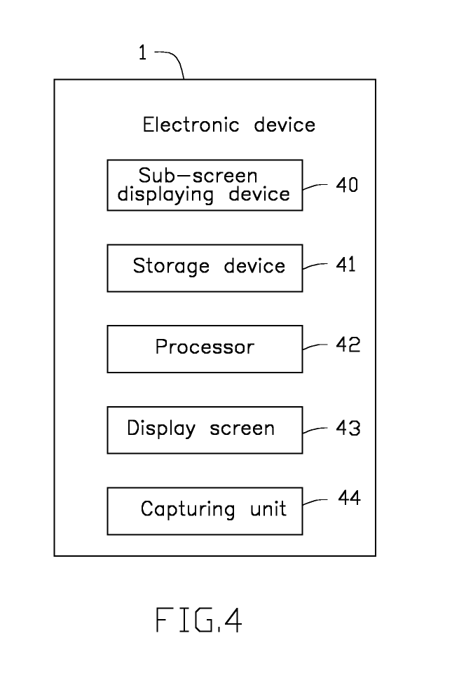

As shown in FIG. 3-4, when the operator M is in the predefined area and watching the sub-screen A and the operator N is in the predefined area of the electronic device and watching the sub-screen B. If the operator N poses the sub-screen establishing gesture 10 while the operator M poses the sub-screen merging gesture 20 at the same time, the capturing unit captures the sub-screen establishing gesture 10 posed by the operator N and the sub-screen merging gesture 20 posed by the operator M. The electronic device is controlled to add the operator N as an co-operator of the sub-screen A according to the sub-screen establishing gesture 10 posed by the operator N and the sub-screen merging gesture 20 posed by the operator M. The electronic device is further controlled to store the relationship between the facial feature of the operator N and the sub-screen A, and delete the relationship between the facial feature of the operator N and the sub-screen B. At this time, the sub-screen A is expanded to cover the screen of the electronic device fully.

In at least one exemplary embodiment, when one of at least two operators, each having their own one sub-screen, is posing the sub-screen merging gesture 20, and the other or another operators pose the sub-screen establishing gesture 10, the capturing unit captures the sub-screen establishing gesture 10 posed by the one of at least two operators and the sub-screen merging gestures 20 posed by the other (or another) operators. The electronic device is controlled to add the other/another operator as an co-operator of the sub-screen related to the one of at least two operators according to the sub-screen establishing gesture 10 posed by the one of at least two operators and the sub-screen merging gestures 20 posed by the other (or another) operators. The electronic device is further controlled to store a relationship between the facial features of the other (or another) operators and the sub-screen related to the one of at least two operators.

As shown in FIG. 3-5, when the operator M is in the predefined area of the electronic device and watching the sub-screen A, the operator N is in the predefined area of the electronic device and watching the sub-screen B. If the operator N poses the sub-screen deleting gesture 30, as the sub-screen B has no other related operators, the electronic device is controlled to delete the sub-screen B, and further delete the relationship between the facial feature of the operator N and the sub-screen B according to the sub-screen deleting gesture 30 posed by the operator N. At this time, as there are now no other sub-screens, the sub-screen A is expanded to fully cover the screen of the electronic device.

As shown in FIG. 3-6, when the operator M and the operator N are in the predefined area and both watching the sub-screen A, the operator N may pose the sub-screen deleting gesture 30. Since sub-screen A has another related operator (operator M), the electronic device is controlled to delete the relationship between the facial feature of the operator N and the sub-screen A.

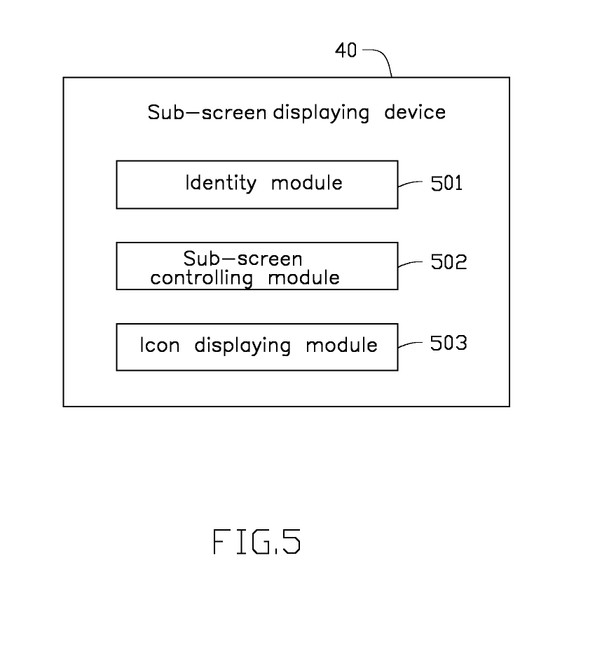

As shown in FIG. 3-7, the operator M is in the predefined area of the electronic device and watching the sub-screen A while the operator N is in the predefined area of the electronic device and watching the sub-screen B at the same time. If the operator N leaves, the electronic device is controlled to stop and hide, or suspend the sub-screen B, as the sub-screen B has no other related operators.

As shown in FIG. 3-8, when the operator N leaves, the sub-screen B is hidden, leaving the operator M to watch the full screen size of the sub-screen A. When the operator N returns, the capturing unit is controlled to capture and identify the facial feature of the operator N, and the electronic device is controlled to display the sub-screen B again.

As the size of the electronic device is limited, the number of the sub-screens is limited. The limit can be a predefined value, such as six. When the number of the sub-screens is equal to the predefined value, a new sub-screen is not allowed to be established, and the new operator can only be allowed and added as an co-operator of a sub-screen.

As the processing speed of the electronic device is also limited, the number of total operators and co-operators cannot be greater than a predefined value, such as ten. When the total number of operators and co-operators is equal to ten, a new operator cannot be allowed.

In at least one exemplary embodiment, a small icon of an operator related to a sub-screen can be displayed on a top right corner of the sub-screen. In at least one exemplary embodiment, the small icon of the operator related to the displaying sub-screen can be displayed on the top right corner of the sub-screen. The small icon relating to the operator of a hidden sub-screen can be displayed on a lower right corner of the screen of the electronic device.

In at least one exemplary embodiment, the small icon of the operator related to the displaying sub-screen can be displayed with one color. The small icon of the operator related to the hidden sub-screen can be displayed with a different color.

FIG. 4 is a block diagram of an exemplary embodiment of an electronic device for realizing the method of displaying sub-screen. The device of displaying sub-screen 40 is set on the electronic device 1. The electronic device 1 can further include a storage device 41, a processor 42, a display screen 43, and a capturing unit 44. Preferably, the method of displaying sub-screen is achieved by the device of displaying sub-screen 40 of the electronic device 1.

The electronic device 1 can be electronic equipment, which can execute numerical computation and/or information processing automatically according to predetermined or stored instructions.

The electronic device 1 can be, but is not limited to, a smart TV, a telephone, a tablet platform, or other suitable electronic device having displaying and human-computer interaction function.

The device of displaying sub-screen 40 can capture a facial feature of an operator and a sub-screen controlling gesture posed within the predefined area by the operator, and control the electronic device to establish, merge, or delete a sub-screen according to the captured sub-screen controlling gesture, and store the relationship between the facial feature of the operator and the sub-screen.

The storage device 41 can be configured to store code of each procedure section of the device of displaying sub-screen 40.

In at least one exemplary embodiment, the storage device 41 can be an internal storage system, such as a flash memory, a random access memory (RAM) for temporary storage of information, and/or a read-memory (ROM) for permanent storage of information.

In at least one exemplary embodiment, the storage device 41 can also be a storage system, such as a hard disk, a storage card, or a data storage medium. The storage device 41 can include volatile and/or non-volatile storage devices.

In at least one exemplary embodiment, the storage device 41 can include two or more storage devices such that one storage device is a memory and the other storage device is a hard drive. Additionally, the storage device 41 can be either entirely or partially external relative to the electronic device 1.

The processor 42 can include one or more micro-processors, digital processors, or, one or micro-controllers, or other suitable processor.

The display screen 43 can be a touch screen or not.

The capturing unit 44 can be mounted on the display screen 43 of the electronic device 43, or located adjacent to the electronic device 1. The capturing unit 44 can be a camera, and/or three-dimensional motion sensors, or the like. The capturing unit 44 can be configured to capture facial features, gestures, and/or limb positions of the operators located within the predefined area of the electronic device 1.

In at least one exemplary embodiment, to obtain a wider visual angle, the capturing unit 44 can include a number of cameras, and/or a number of three-dimensional motion sensors. The cameras and/or the three-dimensional motion sensors can be located anywhere around of the electronic device 1 or located adjacent to the electronic device 1. The cameras and/or the three-dimensional motion sensors can capture pictures from a number of aspects and the pictures can be merged into a single picture.

FIG. 5 a block diagram of a device of displaying sub-screen. The device of displaying sub-screen is provided to carry out the method of FIG. 1. The device of displaying sub-screen 40 can include: an identity module 501 and a sub-screen controlling module 502. The modules of the device of displaying sub-screen 40 can include instructions executed by the processor 42 to achieve specific functions, and stored in the storage device 41.

The identity module 501 can be configured to capture at least one facial feature of at least one operator and a sub-screen controlling gesture posed by the at least one operator within a predefined area of the electronic device.

The sub-screen controlling module 502 is configured to control the electronic device 1 to establish, merge, or delete a sub-screen according to the captured sub-screen controlling gesture, and store the relationship between the facial feature of the operator and the sub-screen into the storage device 41.

As shown in FIG. 3-1, no one is in the predefined area of the electronic device 1. When only the operator M enters the predefined area of the electronic device 1 and poses the sub-screen establishing gesture 10, the identify module 501 is configured to control the capturing unit 44 to capture the sub-screen establishing gesture 10 posed by the operator M and the facial feature of the operator M. The sub-screen controlling module 502 is configured to control the processor 42 of the electronic device 1 to establish the sub-screen A for the operator M according to the sub-screen establishing gesture 10 posed by the operator M. The sub-screen controlling module 502 is further configured to control the storage device 41 to store the relationship between the facial feature of the operator M and the sub-screen A. Therein, the sub-screen A can fully cover the screen of the electronic device 1. For example, the sub-screen A can display a basketball game.

As shown in FIG. 3-2, when the operator M is watching sub-screen A within the predefined area of the electronic device 1 and another operator N may enter the predefined area of the electronic device 1 and poses the sub-screen establishing gesture 10. The identity module 501 is configured to control the capturing unit 44 to capture the sub-screen establishing gesture 10 posed by the operator N and the facial feature of the operator N. The sub-screen controlling module 502 is configured to control the processor 42 of the electronic device 1 to establish the sub-screen B corresponding to the operator N according to the sub-screen establishing gesture 10 posed by the operator N. The sub-screen controlling module 502 is further configured to control the storage device 41 to store the relationship between the facial feature of the operator N and the sub-screen B. Therein, the sub-screen A and the sub-screen B cooperatively cover the screen of the electronic device 1 fully. For example, the sub-screen A is here the basketball game, the sub-screen B is here a cartoon.

As shown in FIG. 3-3, the operator M may be within the predefined area of the electronic device 1 and watching the sub-screen A. The identify module 501 identifies that another operator N is entering the predefined area of the electronic device 1 and posing the sub-screen establishing gesture 10, at the same time, as the operator M, who is posing the sub-screen establishing gesture 10. The identify module 501 is configured to control the capturing unit 44 to capture the sub-screen establishing gesture 10 posed by the operator M and the facial feature of the operator M. The identify module 501 is configured to control the capturing unit 44 to capture the sub-screen establishing gesture 10 posed by the operator N and the facial feature of the operator N. The sub-screen controlling module 502 is configured to control the processor 42 of the electronic device 1 to add the operator N as the co-operator of the sub-screen A according to the sub-screen establishing gesture 10 posed by the operator M and the sub-screen establishing gesture 10 posed by the operator N. The sub-screen controlling module 502 is further configured to control the storage device 41 to store the relationship between the facial feature of the operator N and the sub-screen A in addition to the relationship between operator M and sub-screen A.

As shown in FIG. 3-4, when the operator M is within the predefined area and watching the sub-screen A, and the operator N is also within the predefined area of the electronic device 1 and watching the sub-screen B. The operator N may pose the sub-screen establishing gesture 10 while the operator M pose the sub-screen merging gesture 20 at the same time. The identify module 501 is configured to control the capturing unit 44 to capture the sub-screen establishing gesture 10 posed by the operator N and the sub-screen merging gesture 20 posed by the operator M. The sub-screen controlling module 502 is configured to control the processor 42 of the electronic device 1 to add the operator N as the co-operator of the sub-screen A according to the sub-screen establishing gesture 10 posed by the operator N and the sub-screen merging gesture 20 posed by the operator M. The sub-screen controlling module 502 is further configured to control the storage device 41 to store the relationship between the facial feature of the operator N and the sub-screen A, and delete the relationship between the facial feature of the operator N and the sub-screen B. At this time, the sub-screen A is expanded to cover the screen of the electronic device 1 fully.

In at least one exemplary embodiment, when one of at least two operators, each having one sub-screen, is posing the sub-screen merging gesture 20 and the other or another operators are posing the sub-screen establishing gesture 10, the identify module 501 is configured to control the capturing unit 44 to capture the sub-screen establishing gesture 10 posed by the one of at least two operators and the sub-screen merging gestures 20 posed by the other (or another) operators. The sub-screen controlling module 502 is configured to control the processor 42 of the electronic device 1 to add the other or another operators as co-operators of the sub-screen related to the one of at least two operators according to the sub-screen establishing gesture 10 posed by the one of at least two operators and the sub-screen merging gestures 20 posed by the other (or another) operators. The sub-screen controlling module 502 is further configured to control the storage device 41 to store a relationship between the facial features of the other (or another) operators and the sub-screen related to the one of at least two operators.

As shown in FIG. 3-5, when the operator M is within the predefined area of the electronic device 1 and watching the sub-screen A, the operator N is in the predefined area of the electronic device 1 and watching the sub-screen B at the same time. If the operator N is posing the sub-screen deleting gesture 30, the identify module 501 is configured to control the capturing unit 44 to capture the sub-screen deleting gesture 30. As the sub-screen B has no other related operators, the sub-screen controlling module 502 is configured to control the processor 42 of the electronic device 1 to delete the sub-screen B according to the sub-screen deleting gesture 30 posed by the operator N. The sub-screen controlling module 502 is further configured to control the storage device 41 to store the relationship between the facial feature of the operator N and the sub-screen B. As there are no other sub-screens, the sub-screen A is expanded to fully cover the screen of the electronic device 1.

As shown in FIG. 3-6, when the operator M and the operator N are within the predefined area and both watching the sub-screen A together, the operator N may pose the sub-screen deleting gesture 30. The identify module 501 is configured to control the capturing unit 44 to capture the sub-screen deleting gesture 30. As sub-screen A has another related operator M, the sub-screen controlling module 502 is configured to control the processor 42 of the electronic device 1 to delete the relationship between the facial feature of the operator N and the sub-screen A.

As shown in FIG. 3-7, the operator M may be watching the sub-screen A, and the operator N, who was watching the sub-screen B then leaves the predefined area. As the sub-screen B has no other related operators, the sub-screen controlling module 502 is configured to control the processor 42 of the electronic device 1 to stop and hide, or suspend the sub-screen B formerly watched by operator B.

As shown in FIG. 3-8, when the operator N leaves, the sub-screen B is hidden, leaving the operator M to watch the full screen size of the sub-screen A. When the operator N returns, the identify module 501 is configured to control the capturing unit 44 to capture and identify the facial feature of the operator N. The sub-screen controlling module 502 is configured to control the processor 42 of the electronic device 1 to display of the sub-screen B again when the identity of the operator has been verified.

In at least one exemplary embodiment, the device of displaying sub-screen 40 can further include: an icon-displaying module 503. The icon-displaying module 503 can be configured to control the display screen 43 to display a small icon of an operator related to a sub-screen on a top right corner of the sub-screen. In at least one exemplary embodiment, the icon-displaying module 503 can be further configured to control the display screen 43 to display the small icon of the operator related to the displaying sub-screen on the top right corner of the sub-screen. The icon-displaying module 503 can be further configured to control the display screen 43 to display the small icon relating to the operator of a hidden sub-screen on a lower right corner of the screen of the electronic device 1.

In at least one exemplary embodiment, the icon-displaying module 503 can be further configured to control the display screen 43 to display the small icon of the operator related to the displaying sub-screen can be displayed with one color. The icon-displaying module 503 can be further configured to control the display screen 43 to display the small icon of the operator related to the hidden sub-screen can be displayed with a different color.

The exemplary embodiments shown and described above are only examples. Many details are often found in the art such as the features of method of displaying sub-screen and device using the same. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure up to, and including the full extent established by the broad general meaning of the terms used in the claims. It will therefore be appreciated that the exemplary embodiments described above may be modified within the scope of the claims.

What is claimed is:

1. A method of displaying at least one sub-screen, comprising:
capturing at least one facial feature of at least one operator and at least one sub-screen controlling gesture posed by the at least one operator within a predefine area of an electronic device;
controlling the electronic device to establish, merge, or delete at least one sub-screen according to the at least one captured sub-screen controlling gesture; and
controlling the electronic device to store a relationship between the at least one facial feature of the operator and the sub-screen.

2. The method of displaying sub-screen of claim 1, wherein the sub-screen controlling gesture comprises a sub-screen establishing gesture, the sub-screen establishing gesture is represented by two hands held over a head of the operator, the at least one operator comprises a first operator, the at least one sub-screen comprises a first sub-screen, the method further comprises:
capturing the sub-screen establishing gesture posed by the first operator and the facial feature of the first operator when the first operator entered the predefined area of the electronic device and posed the sub-screen establishing gesture;
controlling the electronic device to establish the first sub-screen corresponding to the first operator according to the sub-screen establishing gesture posed by the first operator; and
controlling the electronic device to store a relationship between the facial feature of the first operator and the first sub-screen.

3. The method of displaying sub-screen of claim 2, wherein the at least one operator further comprises a second operator, the method further comprises:
capturing the sub-screen establishing gesture and the facial feature of the second operator when the first operator and the second operator being within the predefined area of the electronic device, and the first operator simultaneously posing the sub-screen establishing gesture while the second operator posing the sub-screen establishing gesture;
controlling the electronic device to add the second operator as a co-operator of the first sub-screen according to the sub-screen establishing gesture of the second operator and the sub-screen establishing gesture of the first operator; and
controlling the electronic device to store a relationship between the facial feature of the second operator and the first sub-screen.

4. The method of displaying sub-screen of claim 2, wherein the at least one operator further comprises a second operator, the at least one sub-screen further comprises a second sub-screen, the method further comprises:
capturing the sub-screen establishing gesture of the second operator when the second operator entered the predefined area of the electronic device and posed the sub-screen establishing gesture;
controlling the electronic device to establish the second sub-screen corresponding to the second operator according to the sub-screen establishing gesture of the second operator; and
controlling the electronic device to store a relationship between the facial feature of the second operator and the second sub-screen.

5. The method of displaying sub-screen of claim 4, wherein the sub-screen controlling gesture further comprises a sub-screen merging gesture, the sub-screen merging gesture is the two hands clasping over the head of the operator, the method further comprises:
capturing the sub-screen establishing gesture of the second operator and the sub-screen merging gesture of the first operator when the second operator and the second operator being within the predefined area of the electronic device, the second operator posing the sub-screen establishing gesture while the first operator related to the first sub-screen posing the sub-screen merging gesture;
controlling the electronic device to add the second operator as a co-operator of the first sub-screen according to the sub-screen establishing gesture of the second operator and the sub-screen merging gesture of the first operator; and
controlling the electronic device to store a relationship between the facial feature of the second operator and the first sub-screen, and delete the relationship between the facial feature of the second operator and the second sub-screen.

6. The method of displaying sub-screen of claim 1, wherein the sub-screen controlling gesture comprises a sub-screen deleting gesture, the sub-screen deleting gesture is two hands crossing over a head of the operator, the method further comprises:
capturing the sub-screen deleting gesture when the operator posing the sub-screen deleting gesture in the predefined area of the electronic device, and the sub-screen having no other related operators;
controlling the electronic device to delete the sub-screen according to the sub-screen deleting gesture posed by the operator; and
controlling the electronic device to delete the relationship between the facial feature of the operator and the sub-screen according to the sub-screen deleting gesture posed by the operator.

7. The method of displaying sub-screen of claim 1, wherein the sub-screen controlling gesture comprises a sub-screen deleting gesture, the sub-screen deleting gesture is two hands crossing over a head of the operator, the method further comprises:
capturing the sub-screen deleting gesture when the operator is posing the sub-screen deleting gesture in the predefined area of the electronic device, and the sub-screen has other related operators; and
controlling the electronic device to delete the relationship between the facial feature of the operator and the sub-screen according to the sub-screen deleting gesture posed by the operator.

8. The method of displaying sub-screen of claim 7, wherein the method further comprises:
controlling the electronic device to stop the sub-screen and hide the sub-screen when the operator leaves and the sub-screen has no other related operators.

9. The method of displaying sub-screen of claim 8, wherein the method further comprises:
controlling the electronic device to display the sub-screen again when the operator returns and an identity of the operator has been verified.

10. A device of displaying sub-screen, comprising:
a plurality of processors; and
a plurality of non-transitory computer storage mediums, coupled to the plurality of processors and configured to store instructions for execution by the plurality of processors, the instructions causing the plurality of processors to:
capture at least one facial feature of at least one operator and at least one sub-screen controlling gesture posed by the at least one operator within a predefine area of an electronic device;
control the electronic device to establish, merge, or delete at least one sub-screen according to the captured at least one sub-screen controlling gesture; and
control the electronic device to store a relationship between the at least one facial feature of the operator and the sub-screen.

11. The device of displaying sub-screen of claim 10, wherein the sub-screen controlling gesture comprises a sub-screen establishing gesture, the sub-screen establishing gesture is represented by two hands held over a head of the operator, the at least one operator comprises a first operator, the at least one sub-screen comprises a first sub-screen, the instructions further cause the plurality of processors to:
capture the sub-screen establishing gesture posed by the first operator and the facial feature of the first operator when the first operator entered the predefined area of the electronic device and posed the sub-screen establishing gesture;
control the electronic device to establish the first sub-screen corresponding to the first operator according to the sub-screen establishing gesture posed by the first operator; and; and
control the electronic device to store a relationship between the facial feature of the first operator and the first sub-screen.

12. The device of displaying sub-screen of claim 11, wherein the at least one operator further comprises a second operator, the instructions further cause the plurality of processors to:
capture the sub-screen establishing gesture and the facial feature of the second operator when the first operator and the second operator being within the predefined area of the electronic device, and the first operator simultaneously posing the sub-screen establishing gesture while the second operator posing the sub-screen establishing gesture;
control the electronic device to add the second operator as a co-operator of the first sub-screen according to the sub-screen establishing gesture of the second operator and the sub-screen establishing gesture of the first operator; and
control the electronic device to store a relationship between the facial feature of the second operator and the first sub-screen.

13. The device of displaying sub-screen of claim 11, wherein the at least one operator further comprises a second operator, the at least one sub-screen further comprises a second sub-screen, the instructions further cause the plurality of processors to:
capture the sub-screen establishing gesture of the second operator when the second operator entered the predefined area of the electronic device and posed the sub-screen establishing gesture;
control the electronic device to establish the second sub-screen corresponding to the second operator according to the sub-screen establishing gesture of the second operator; and
control the electronic device to store a relationship between the facial feature of the second operator and the second sub-screen.

14. The device of displaying sub-screen of claim 13, wherein the sub-screen controlling gesture further comprises a sub-screen merging gesture, the sub-screen merging gesture is the two hands clasping over the head of the operator, the instructions further cause the plurality of processors to:
capture the sub-screen establishing gesture of the second operator and the sub-screen merging gesture of the first operator when the second operator and the second operator being within the predefined area of the electronic device, the second operator posing the sub-screen establishing gesture while the first operator related to the first sub-screen posing the sub-screen merging gesture;
control the electronic device to add the second operator as a co-operator of the first sub-screen according to the sub-screen establishing gesture of the second operator and the sub-screen merging gesture of the first operator; and
control the electronic device to store a relationship between the facial feature of the second operator and the first sub-screen, and delete the relationship between the facial feature of the second operator and the second sub-screen.

15. The device of displaying sub-screen of claim 10, wherein the sub-screen controlling gesture comprises a sub-screen deleting gesture, the sub-screen deleting gesture is two hands crossing over a head of the operator, the instructions further cause the plurality of processors to:
capture the sub-screen deleting gesture when the operator posing the sub-screen deleting gesture in the predefined area of the electronic device, and the sub-screen having no other related operators;
control the electronic device to delete the sub-screen according to the sub-screen deleting gesture posed by the operator; and
control the electronic device to delete the relationship between the facial feature of the operator and the sub-screen according to the sub-screen deleting gesture posed by the operator.

16. The device of displaying sub-screen of claim 10, wherein the sub-screen controlling gesture comprises a sub-screen deleting gesture, the sub-screen deleting gesture is two hands crossing over a head of the operator, the instructions further cause the plurality of processors to:
capture the sub-screen deleting gesture when the operator is posing the sub-screen deleting gesture in the predefined area of the electronic device, and the sub-screen has other related operators; and
control the electronic device to delete the relationship between the facial feature of the operator and the sub-screen according to the sub-screen deleting gesture posed by the operator.

17. The device of displaying sub-screen of claim 10, wherein the instructions further cause the plurality of processors to:
control the electronic device to stop the sub-screen and hide the sub-screen when the operator leaves and the sub-screen has no other related operators.

18. The device of displaying sub-screen of claim 17, wherein the instructions further cause the plurality of processors to:
control the electronic device to display the sub-screen again when the operator returns and an identity of the operator has been verified.
